(19) United States
(12) Patent Application Publication
(10) Pub. No.: US 2016/0040518 A1
(43) Pub. Date: Feb. 11, 2016

(54) WELL TREATMENT FLUIDS

(71) Applicant: SCHLUMBERGER TECHNOLOGY CORPORATION, Sugar Land, TX (US)

(72) Inventors: Dmitriy Potapenko, Sugar Land, TX (US); James Ernest Brown, Sugar Land, TX (US)

(21) Appl. No.: 14/453,277

(22) Filed: Aug. 6, 2014

(51) Int. Cl. E21B 43/16; C09K 8/68; E21B 43/26

(52) U.S. Cl. CPC E21B 43/16; E21B 43/26; C09K 8/68

(57) ABSTRACT

In-line electrolysis of well treatment fluid in a method and system to supply a treatment fluid downhole in the well. In the method, a treatment fluid is electrolyzed in a flow path to a downhole location to form one or more electrolysis products. In the system, an electrolysis cell has at least one electrode integrated in the flow path. Also disclosed is a method to treat a subterranean formation by modulating amperage to an electrolysis cell in the flow path to form a heterogeneous concentration of one or more electrolysis products to transform a self-agglomerating solid composition in the fracture into a channelized solids pack comprising clusters having a high concentration of solids, wherein the clusters are separated by open voids having a substantially reduced concentration of solids between the clusters.

### RELATED APPLICATION DATA

None.

### BACKGROUND

The statements in this section merely provide background information related to the present disclosure and may not constitute prior art.

The present disclosure relates to methods of formulating well treatment fluids and pumping them downhole. Such fluids may comprise various functional additives used for providing the treatment fluid with the required properties. Well treatment fluids may be prepared at a remote location and brought to the well treatment location for use, or more commonly may be prepared on-site from different additives or additive formulations by mixing the components together before or while pumping the treatment fluid downhole.

The precise control of treatment fluid rheology is useful in many applications. In some applications, it is useful to vary the presence or concentration of one or more components in a treatment fluid, e.g., in adjacent pulses or slugs of a continuously pumped or injected treatment fluid. Frequently, mixing phenomenon between the adjacent pulses or slugs leads to undesired blurring of component concentrations, especially during long, turbulent transit from surface to subterranean formation, may require the use of spacer fluids or other elements between adjacent pulses or slugs, and/or a feasible minimum volume of pulses or slugs may be larger than desired for a particular application.

The mixing procedure is often complicated by high wellbore injection pressures, high volumetric injection rates and the use of multistage positive displacement pumps, as well as components which may be reactive prior to or after introduction into the treatment fluid, which can lead to uneven mixing, undesired mixing between pulses or slugs of different component concentrations, undesired variability in component concentrations and concomitant undesired variability of fluid properties.

Industry would welcome improvements in the on-site preparation and pumping of well treatment fluids that addresses one or more of the foregoing issues.

### SUMMARY

The disclosed subject matter of the application in some embodiments provides methods and systems to prepare and/or pump well treatment fluids using in-line electrolysis techniques.

In some embodiments according to the present disclosure, methods to supply a treatment fluid downhole to a well comprise flowing a treatment fluid through a treating line in a flow path to a downhole location in the well; and electrolyzing the treatment fluid in the flow path to form one or more electrolysis products in the treatment fluid.

In some embodiments according to the present disclosure, methods to form additives in treatment fluids in situ during injection of the treatment fluid downhole comprise electrolysis, in a flow path to the downhole location, of at least a portion of the treatment fluid, comprising electrolyzable precursors, referred to herein as electrolysis reactants, to form the additives as the products of the electrolysis, e.g., to increase or decrease the viscosity, such as by, for example, crosslinking or breaking. In some embodiments, the amount of the electrolysis products formed in the treatment fluid can be controlled by amperage according to Faraday's laws of electrolysis. In some embodiments, the additives can be formed on-the-fly during pumping of the treatment fluid downhole.

In some embodiments, the treatment fluids comprise one or more electrolysis reactants, dispersed in an electrically conductive fluid, and converted to the one or more electrolysis products in the electrolyzing. In some embodiments, the treatment fluids comprise aqueous halide salt converted to hypohalite in the electrolyzing, e.g., potassium and/or sodium chloride is converted to hypochlorite. In some embodiments, the treatment fluids comprise a viscosified fracturing fluid and the hypohalite is a breaker for the fracturing fluid.

In some embodiments, the treatment fluids comprise one or more carboxylic acids to form carbon dioxide and hydroxyl ion in the electrolyzing to raise the pH of the treatment fluid. In some embodiments, the treatment fluids comprise a crosslinkable component and the raising of the treatment fluid pH activates crosslinking of the crosslinkable component.

In some embodiments, the methods further comprise passing the treatment fluid through an electrolysis cell integrated into the flow path. In some embodiments, the electrolysis cells comprise spatially separated electrodes. In some embodiments according to the present disclosure, one or more of the spatially separated electrodes are positioned upstream of the well and/or downhole in the well. In some embodiments, the electrodes are spatially separated across a pump in the treating line. In some embodiments, a first one of the electrodes is disposed in the treating line and a second one of the electrodes of opposite polarity to the first one of the electrodes is disposed in a tank in fluid communication with the treating line.

In some embodiments according to the present disclosure, systems to supply a treatment fluid downhole to a well comprise an electrically conductive treatment fluid source; a motive unit to flow the treatment fluid through a treating line in a flow path from the treatment fluid source to a downhole location in the well; an electrolysis cell comprising a plurality of electrodes disposed in electrically conductive relation with the treatment fluid and comprising at least one of the electrodes integrated in the flow path; and an electrical source to apply a voltage across the plurality of electrodes to form one or more electrolysis products in the treatment fluid, e.g., to increase or decrease the viscosity, such as by, for example, crosslinking or breaking.

In some embodiments, the treatment fluids comprise one or more electrolysis reactants to form the one or more electrolysis products. In some embodiments, the treatment fluids comprise aqueous halide salt and the one or more electrolysis products comprise hypohalite. In some embodiments, the treatment fluid comprises a viscosified fracturing fluid and the hypohalite is a breaker for the fracturing fluid. In some embodiments, the treatment fluid comprises one or more carboxylic acids and the one or more electrolysis products comprise pH modifiers to raise the pH of the treatment fluid. In some embodiments, the treatment fluid comprises a crosslinkable component and the pH modifiers are activators to activate crosslinking of the crosslinkable component.

In some embodiments, the systems further comprise a controller to adjust amperage and/or voltage between the electrodes. In some embodiments, the electrolysis cell is positioned upstream of the well. In some embodiments, the electrolysis cell is positioned downhole in the well. In some embodiments, the motive unit comprises a pump and the electrodes are spatially separated across a pump in the treating line. In some embodiments, a first one of the electrodes is disposed in the treating line and a second one of the electrodes of opposite polarity to the first one of the electrodes is disposed in a tank in fluid communication with the treating line.

In some embodiments according to the present disclosure, methods to treat a subterranean formation penetrated by a wellbore comprise: providing a treatment fluid stage comprising a particulate-containing substage comprising a self-agglomerating solid composition; injecting the treatment fluid stage above a fracturing pressure through a treating line and a wellbore in a flow path to a fracture in the formation; modulating amperage to an electrolysis cell in the flow path to form a heterogeneous concentration of one or more electrolysis products to transform the self-agglomerating solid composition in the fracture into a channelized solids pack comprising clusters having a high concentration of solids, wherein the clusters are separated by open voids having a substantially reduced concentration of solids between the clusters; and closing the fracture onto the clusters.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

These and other features and advantages will be better understood by reference to the following detailed description when considered in conjunction with the accompanying drawings.

FIG. 1 schematically illustrates an electrolysis cell in a well treatment fluid flow path according to embodiments of the present disclosure.

FIG. 2 schematically illustrates an electrolysis cell in a well treatment fluid flow path downstream from a pump according to embodiments of the present disclosure.

FIG. 3 schematically illustrates an electrolysis cell with spatially separated electrodes in a well treatment fluid flow path according to embodiments of the present disclosure.

FIG. 4 schematically illustrates an electrolysis cell with a spatially separated electrode in a treatment fluid supply tank in communication with the well treatment fluid flow path according to embodiments of the present disclosure.

FIG. 5 schematically illustrates an electrolysis cell with a spatially separated electrode in an additive tank in communication with the well treatment fluid flow path according to embodiments of the present disclosure.

FIG. 6 illustrates a pumping sequence of a proppant-laden substage with electrolysis products formed by modulation of the electrical current according to embodiments of the present disclosure.

FIG. 7 schematically illustrates proppant distribution in a fracture upon placement according to embodiments of the present disclosure.

FIG. 8 schematically illustrates proppant distribution in the fracture of FIG. 7 following heterogeneous settling according to embodiments of the present disclosure.

FIG. 9 schematically illustrates a propped fracture having proppant clusters separated by open voids within a propped region of the fracture according to embodiments of the present disclosure.

FIG. 10 schematically illustrates a fracture filled with alternating stages of homogenous proppant-rich and proppant-lean treatment fluids.

FIG. 11 schematically illustrates a fracture filled with alternating stages of in situ channelizing proppant-rich treatment fluid and proppant-lean treatment fluid, wherein the volume of the proppant rich treatment fluid is greater than that of the proppant lean treatment fluid, according to embodiments of the present disclosure.

FIG. 12 schematically illustrates a fracture filled with alternating stages of in situ channelizing proppant-rich treatment fluid and proppant-lean treatment fluid, wherein the volume of the proppant rich treatment fluid is substantially greater than that of the proppant lean treatment fluid, according to further embodiments of the present disclosure.

FIG. 13 is a sectional view of a portion of the propped fracture of FIG. 12 as seen along the view lines 13-13.

### DETAILED DESCRIPTION OF SOME ILLUSTRATIVE EMBODIMENTS

For the purposes of promoting an understanding of the principles of the disclosure, reference will now be made to some illustrative embodiments of the current application.

For the purposes of promoting an understanding of the principles of the disclosure, reference will now be made to some illustrative embodiments of the current application. Like reference numerals used herein refer to like parts in the various drawings. Reference numerals without suffixed letters refer to the part(s) in general; reference numerals with suffixed letters refer to a specific one of the parts.

As used herein, “embodiments” refers to non-limiting examples of the application disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Moreover, the schematic illustrations and descriptions provided herein are understood to be examples only, and components and operations may be combined or divided, and added or removed, as well as re-ordered in whole or part, unless stated explicitly to the contrary herein. Certain operations illustrated may be implemented by a computer executing a computer program product on a computer readable medium, where the computer program product comprises instructions causing the computer to execute one or more of the operations, or to issue commands to other devices to execute one or more of the operations.

It should be understood that, although a substantial portion of the following detailed description may be provided in the context of oilfield hydraulic fracturing operations, other oilfield operations such as drilling, cementing, gravel packing, etc., or even non-oilfield well treatment operations, can utilize and benefit as well from the instant disclosure.

In some embodiments according to the disclosure herein, an in-line well treatment fluid electrolysis method and system are provided for on-the-fly preparation or modification of well treatment fluids and/or formation of additives (electrolysis products) in the well treatment fluid, such as, for example, hypohalite from electrolysis of aqueous halide, which may be used, e.g., as a breaker in some embodiments, pH modifiers (alkaline or basic compounds) to raise the pH, which may be used, e.g., to activate crosslinking of a viscosifier such as a polymer.

As used herein, “in-line” refers to electrolysis in the flow path, either in a main line carrying the bulk of the treatment fluid or in a sidestream, i.e., where electrodes are disposed in relation to the flow path so as to cause an electrical current to flow through the fluid in the flow path or any portion thereof. “Flow path” refers to the route(s) of travel of the treatment fluid from a tank, reservoir or other source containing the treatment fluid or each of any components thereof, through any hydraulically conductive structure such as, for example, a treating line, manifold, pump, wellbore, perforation or the like as may be present, to an ultimate destination, such as, for example, fracture or matrix in a subterranean formation which may be penetrated by the wellbore, when present, inclusive of the source(s) and ultimate destination(s). Fluid may flow through the flow path continuously or intermittently, that is, the flow path exists before fluid flow initiation and after flow cessation, as well as during any interruptions between periods of fluid flow. “On the fly” refers to in line electrolysis of the treatment fluid as it travels continuously or intermittently through the flow path.

In some embodiments, the method further comprises passing the treatment fluid through an electrolysis cell integrated into the flow path. In some embodiments, the electrolysis cell comprises spatially separated electrodes. In some embodiments according to the present disclosure, one or more of the spatially separated electrodes are positioned upstream of the well and/or downhole in the well. In some embodiments, the electrodes are spatially separated across a pump in the treating line. In some embodiments, a first one of the electrodes is disposed in the treating line and a second one of the electrodes of opposite polarity to the first one of the electrodes is disposed in a tank in fluid communication with the treating line.

With reference to embodiments of the present disclosure represented schematically in FIG. 1, an electrolysis cell 10 is disposed in a well treatment fluid flow path 12, e.g., in a treating line located at the surface, or downhole in a vertical or non-vertical portion of a wellbore. The electrolysis cell 10 generally includes a conductive anode solution adjacent at least one anode and a conductive catholyte solution adjacent at least one cathode, which may optionally be separated into respective anolyte and catholyte compartments by an electrically conductive membrane and/or a permeable or semipermeable membrane. The treatment fluid may be the anolyte solution, the catholyte solution or both, and/or a separate fluid may be used as the catholyte and/or anolyte solution.

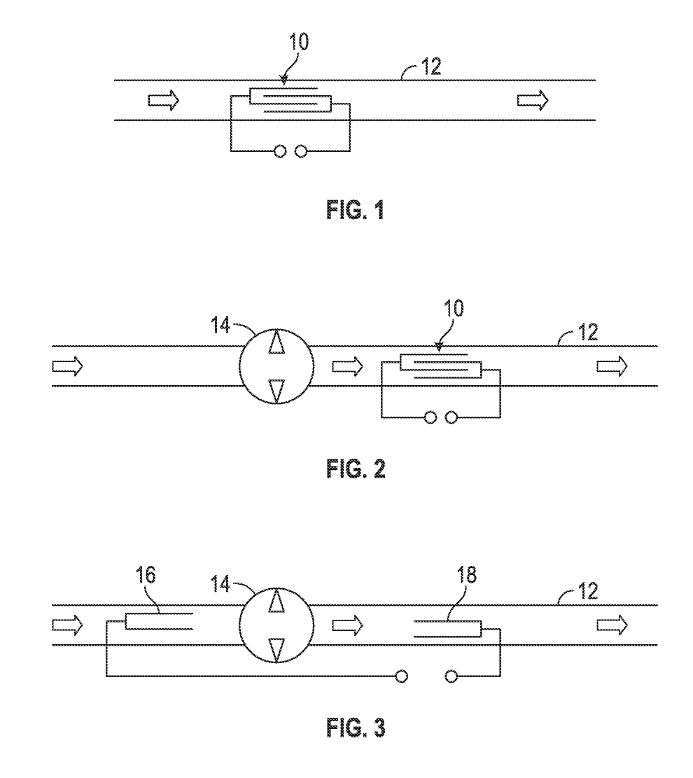

In the embodiments of the present disclosure represented schematically in FIG. 2, the electrolysis cell 10 is disposed downstream from a fluid moving device such as pump 14. For example, the electrolysis cell may be disposed downhole in the wellbore, e.g., near a formation receiving the treatment fluid, or may be disposed in a surface treating line leading to the wellbore.

In the embodiments of the present disclosure represented schematically in FIG. 3, an upstream or low pressure electrode 16 in the flow path 12 is spatially separated from another downstream or high pressure electrode 18 in the flow path, such as, for example, across, or in opposite flow path approaches to, pump 14. In embodiments, the electrodes 16, 18 are oppositely charged, e.g., electrode 16 is an anode and electrode 18 a cathode, or electrode 18 is the anode and electrode 18 the cathode.

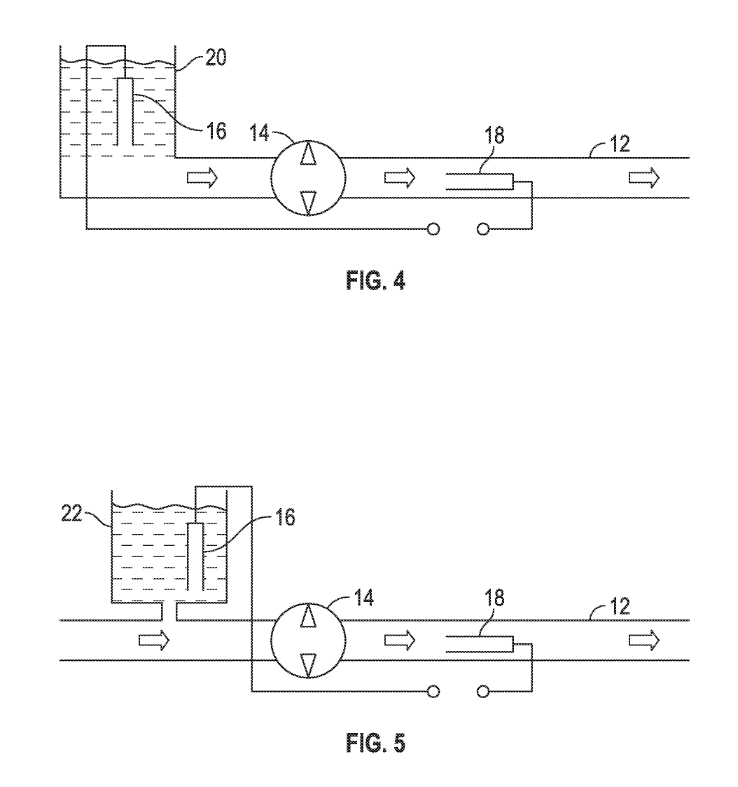

In the embodiments of the present disclosure represented schematically in FIG. 4, the electrode 16 is disposed in a tank 20 supplying a pre-mixed treatment fluid to the flow path 12, e.g., into a treating line upstream from the pump 14, and the electrode 18 is disposed in a portion of the flow path 12 downstream from the pump or in the high pressure side, e.g., in a surface treating line or downhole in the wellbore or formation.

In the embodiments of the present disclosure represented schematically in FIG. 5, the electrode 16 is disposed in a tank 22 supplying a treatment fluid additament to the treatment fluid portion in the flow path 12, e.g., into a treating line upstream from the pump 14, and the electrode 18 is disposed in a portion of the flow path 12 downstream from the pump or in the high pressure side, e.g., in a surface treating line or downhole in the wellbore or formation.

In some embodiments, the treatment fluid comprises one or more electrolysis reactants, dispersed in an electrically conductive fluid, and converted to the one or more electrolysis products in the electrolyzing. In some embodiments according to the present disclosure, the formation of additives in the treatment fluid in situ during injection of the treatment fluid downhole is achieved by the electrolysis of at least a portion of the treatment fluid, which comprises electrolyzable precursors, referred to herein as the electrolysis reactants. These reactants form the additives as the products of the electrolysis. In some embodiments, the additives can be formed on-the-fly during pumping of the treatment fluid downhole.

In some embodiments, the formation of the electrolysis product(s) is in an amount to modify a rheology of the treatment fluid, e.g., to increase or decrease the viscosity. As used herein, rheology modification refers to a change, e.g., in some embodiments of 5% or more, in one or more rheological properties at relevant shear rates, such as, for example, kinematic or absolute (also known as dynamic) viscosity, yield stress, rheopecty, thixotropy, or the like. Relevant shear rates are those experienced by the treatment fluid after electrolysis, e.g., from 0 or rest (no shear) up to 300 s⁻¹ or more. The rheology modification may be instantaneous, or near instantaneous with the electrolysis, or it may be delayed by reaction kinetics applicable to the electrolysis product(s). For example, the treatment fluid may comprise aqueous halide salt as an electrolyzable precursor that is converted to hypohalite in the electrolyzing, e.g., potassium and/or sodium chloride converted to hypochlorite according to the following reactions:

$$\frac{\begin{matrix}anode \text{:} {Cl}^{-} + {H}_{2} O = 2 {H}^{+} + {ClO}^{-} + 2 e \\ cathode \text{:} 2 {H}^{+} + 2 e = {H}_{2}\end{matrix}}{{Cl}^{-} + {H}_{2} O = {ClO}^{-} + {H}_{2}}$$

The formation of hypohalite species in sufficient quantity may in some embodiments reduce the viscosity of a treatment fluid viscosified with a polymer or a viscoelastic surfactant by breaking the treatment fluid, i.e., the hypohalite or other electrolysis product(s) functions as a breaker, breaker aid or breaker trigger or accelerator in these fluids to reduce viscosity by decrosslinking, depolymerization or micelle disruption or disentanglement, or the like. In some embodiments, the treatment fluid comprises a viscosified fracturing fluid and the hypohalite is a breaker for the fracturing fluid.

As another example, the pH of the treatment fluid may be controllably increased by electrolysis of water soluble salts of carboxylic acids by decarboxylative dimerization, e.g., according to Kolbe's reaction as follows:

$$\frac{\begin{matrix}anode \text{:} 2 {RCOO}^{-} = 2 {CO}_{2} + RR + 2 e \\ cathode \text{:} 2 {H}_{2} O + 2 e = {H}_{2} + 2 {OH}^{-}\end{matrix}}{2 {RCOO}^{-} + 2 {H}_{2} O = 2 {CO}_{2} + RR + {H}_{2} + 2 {OH}^{-}}$$

wherein R is a hydrocarbyl radical or a mixture of hydrocarbyl radicals. It is thus seen that the electrolysis will raise the pH in some embodiments. In some embodiments, the treatment fluid comprises one or more carboxylic acids to form carbon dioxide and hydroxyl ion in the electrolyzing to raise the pH of the treatment fluid. In some embodiments, the treatment fluid comprises a crosslinkable component and the raising of the treatment fluid pH activates crosslinking of the crosslinkable component. Elevating the pH may in some embodiments activate crosslinking and thereby increase the viscosity of the treatment fluid. For example, guar can be crosslinked with a borate crosslinker at elevated pH, e.g., 8.5 to 12.

The electrolysis product(s) can also comprise nonionic components that alter the properties of the treatment fluid. In the foregoing examples, for example, gaseous components such as carbon dioxide, hydrogen or the like may be formed at one or more of the electrodes, which can change the foam quality where the treatment fluid is energized, or alter the hydrophobic-hydrophilic balance and/or solubilizing characteristics depending on the nature of the gas, e.g., carbon dioxide can increase the solubility of hydrocarbons.

In some embodiments, the amount of the electrolysis products formed in the treatment fluid can be controlled by amperage according to Faraday's laws of electrolysis, which can be summarized as follows: m=(Q/F)(M/z), wherein m is the mass (g) of the electrolysis product liberated at an electrode, Q is the total electric charge supplied (coulombs) to the electrode, F is the Faraday constant (96485 C/mol), M is molar mass of the electrolysis product, and z is the valency number of electrons transferred to or from the electrolysis product at the electrode. In the case of a constant direct current, the equation Q=It is applicable, where I is the current (amperes) and t is the time the current is applied. For variable current such as alternating current, for example, the following equation is applicable:

Q=∫₀^{t}I(τ)dτ

wherein I(τ) is the current as a function of time τ.

The concentration of the electrolysis product that is formed is determined as the mass m relative to the volume of electrolyzed treatment fluid. In dynamic conditions (electrolysis of a flowing treatment fluid) the concentration of the electrolysis product is the mass m formed per unit time divided by the volumetric flow rate of the treatment fluid. In static conditions (a closed or non-flowing electrolytic cell) the concentration of the electrolysis product is the mass m formed divided by the volume of the treatment fluid subjected to electrolysis. The concentration of the electrolysis product can thus be controlled by adjusting the ratio of the current to the volume of treatment fluid subjected to electrolysis.

The electrolysis cell 10 in various embodiments may be operated continuously, e.g., while the treatment fluid flows through the flow path 12, or in batch or semibatch mode, e.g., while the treatment fluid is held in place in the vicinity of the electrolysis cell, or may be modulated while the treatment fluid flows to produce different concentrations of electrolysis product(s) in different regions of the treatment fluid, e.g., pulses or slugs of different concentrations of the electrolysis product(s). Moreover, placement of the electrolysis cell or electrode(s) in the wellbore near the formation being treated, by avoiding mixing of the electrolysis products in transit from the surface, and reducing the post-electrolysis transit time and distance during which mixing might occur, allows in some embodiments for a sharper component concentration modulation between adjacent pulses of slugs, with less blurring, and/or for relatively smaller volumes of pulses or slugs.

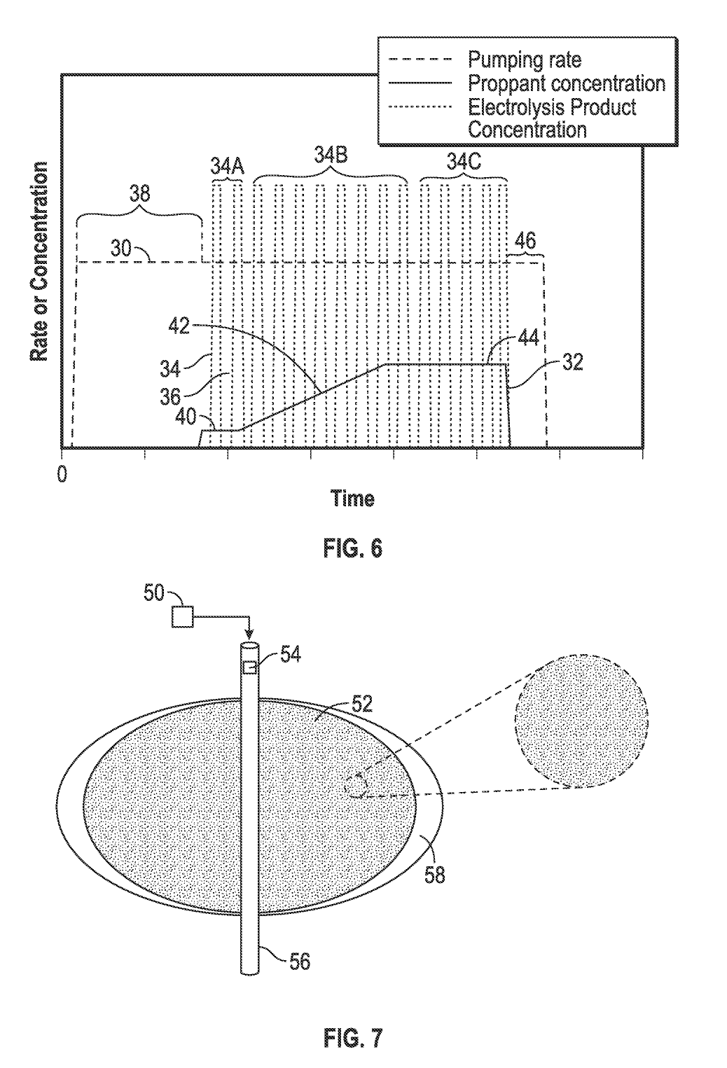

As seen in FIG. 6, a pumping sequence used in some hydraulic fracturing embodiments has a continuous pumping rate 30, a continuous proppant concentration 32 (with respect to the liquid carrier phase) and a modulated electrolysis current between on and off modes 34, 36. In these embodiments, the proppant loading may follow a proppant-free pad stage 38 beginning at a relatively low proppant loading 40 which after one or more electrolysis current pulses 34A, may have a smooth ramp 42 up over a series of electrolysis current pulses 34B to a higher proppant loading 44, and then be maintained at a constant rate 44 for an additional series of electrolysis current pulses 34C until the proppant stage 32 is ended, and followed by a flush stage 46. In this manner, alternating slugs or pulses of treatment fluid with continuous proppant loading may have alternating electrolysis product(s) concentration, which in some embodiments, may trigger destabilization or other processes for formation of clusters of proppant or other solids in the treatment fluid for in situ channelization of the fracture.

By “in situ channelization” it is meant herein that channels of relatively high hydraulic conductivity are formed between particulate clusters in a fracture after at least a portion of the fracture has been filled with a generally continuous proppant or other particle concentration or regions of continuous proppant concentration. The following discussion refers to proppant as one example of a first solid particle which may be used in the present disclosure, although other types of solid particles are contemplated. The terms proppant and sand are used interchangeably herein.

The term “self-agglomerating solid composition” refers to an in situ treatment fluid system wherein a generally uniform region or island of solids placed into a formation automatically coalesces into proppant clusters within the region or island separated by open voids between the clusters within the region nor island.

The treatment fluid may comprise a liquid or foamed carrying fluid. The term “foamed carrying fluid” is used interchangeably with “energized fluid” and “foam” to refer to a fluid which when subjected to a low pressure environment liberates or releases gas from solution or dispersion, for example, a liquid containing dissolved gases. Foams or energized fluids are stable mixtures of gases and liquids that form a two-phase system. Foam and energized fluids are generally described by their foam quality, i.e. the ratio of gas volume to the foam volume (fluid phase of the treatment fluid), i.e., the ratio of the gas volume to the sum of the gas plus liquid volumes). If the foam quality is between 52% and 95%, the energized fluid is usually called foam. Above 95%, foam is generally changed to mist. In the present patent application, the terms “foamed carrying fluid” and “energized fluid” encompass both energized fluids and foams and refer to any stable mixture of gas and liquid, regardless of the foam quality. Foamed carrying fluids comprise any of:
(a) Liquids that at bottom hole conditions of pressure and temperature are close to saturation with a species of gas. For example the liquid can be aqueous and the gas nitrogen or carbon dioxide. Associated with the liquid and gas species and temperature is a pressure called the bubble point, at which the liquid is fully saturated. At pressures below the bubble point, gas emerges from solution;
(b) Foams, consisting generally of a gas phase, an aqueous phase and a solid phase. At high pressures the foam quality is typically low (i.e., the non-saturated gas volume is low), but quality (and volume) rises as the pressure falls. Additionally, the aqueous phase may have originated as a solid material and once the gas phase is dissolved into the solid phase, the viscosity of solid material is decreased such that the solid material becomes a liquid; or
(c) Liquefied gases.

As used herein, “destabilization” of a foamed fluid refers to the formation of large gas bubbles, e.g., the coalescence of fine gas bubbles into larger bubbles, which are incapable of supporting any solid particles which may be present, resulting in the formation of solid particle clusters adjacent to the bubbles. In some embodiments, the foam quality can be used as a parameter to adjust the destabilization rate of the treatment fluid, e.g., higher foam quality may lead to more destabilization and larger proppant clusters, and/or alternating pulses of different foam quality, e.g., pulses of 80% foam quality alternated with 75% foam quality pulses, or 70% and 40%, or 50% and 0%, or the like, where the liquid carrier fluid phase has an otherwise continuous composition and proppant loading, may enable different proppant settling rates between the adjacent pulses and a heterogeneous proppant distribution, and thus a heterogeneous conductivity distribution.

As used herein, a “hydraulically conductive fracture” is one which has a high conductivity relative to the adjacent formation matrix, whereas the term “conductive channel” refers to both open channels as well as channels filled with a matrix having interstitial spaces for permeation of fluids through the channel, or channels filled with proppant islands of proppant clusters wherein the proppant clusters are spaced apart by open voids between the proppant clusters, such that the channel has a relatively higher conductivity than adjacent non-channel areas.

As used herein, “compound cluster placement” refers to a fracture system comprising proppant islands spaced apart by open channels wherein the proppant islands are each comprised of a plurality of proppant clusters, each proppant cluster comprising a plurality of proppant particles in contact with adjacent particles, wherein the spacing between the proppant clusters within a proppant island is much less than the spacing between adjacent proppant islands, e.g., an order of magnitude less. Proppant clusters may or may not be porous, e.g., they may have a packed volume fraction from 50 to 100% with interstitial flow paths on the order of the largest particle size, whereas proppant islands in a compound cluster placement system may each comprise a plurality of clusters with intermediate sized flow channels or voids between the clusters, which are generally smaller than the relatively larger open flow cannels between the islands.

Proppant coverage refers to the area of a fracture along its extent which contains the proppant islands or other propped regions in relation to the total area of the extent of the fracture. Because of the close proximity of the clusters within the islands relative to the stiffness and closure stress, the entire area of the island may be considered to be propped. The “channel breadth” refers to the distance between the propped regions. Modeling tools such as FracCADE, available from Schlumberger Technology Corporation may be used to determine, based on the closure stress, e.g., the overburden pressure, and the stiffness or rigidity of the formation at the fracture face, the maximum channel breadth that can be tolerated before the fracture will collapse and opposing faces of the fracture between the adjacent islands will be closed off. In some embodiments, the treatment is designed to avoid collapse of the channels, or to minimize risk of collapse, by providing open channels between the proppant islands which generally do not exceed the maximum allowable open channel breadth for the particular fracture closure stress and stiffness.

The term “continuous” in reference to concentration or other parameter as a function of another variable such as time, for example, means that the concentration or other parameter is an uninterrupted or unbroken function, which may include relatively smooth increases and/or decreases with time, e.g., a smooth rate or concentration of proppant particle introduction into a fracture such that the distribution of the proppant particles is free of repeated discontinuities and/or heterogeneities over the extent of proppant particle filling. In some embodiments, a relatively small step change in a function is considered to be continuous where the change is within +/−10% of the initial function value, or within +/−5% of the initial function value, or within +/−2% of the initial function value, or within +/−1% of the initial function value, or the like over a period of time of 1 minute, 10 seconds, 1 second, or 1 millisecond. The term “repeated” herein refers to an event which occurs more than once in a stage.

Conversely, a parameter as a function of another variable such as time or rate, for example, is “discontinuous” wherever it is not continuous, and in some embodiments, a repeated relatively large step function change is considered to be discontinuous, e.g., where the lower one of the parameter values before and after the step change is less than 80%, or less than 50%, or less than 20%, or less than 10%, or less than 5%, or less than 2% or less than 1%, of the higher one of the parameter values before and after the step change over a period of time of 1 minute, 10 seconds, 1 second, or 1 millisecond.

In embodiments, the open voids between the clusters within the proppant fill or proppant islands may be formed in situ after placement of the proppant and/or proppant islands in the fracture by differential movement of the proppant particles, e.g., by foam destabilization, by coalescence of a binding liquid around the agglomerant and/or proppant particles, by gravitational settling and/or fluid movement such as fluid flow initiated by a flowback operation, out of and/or away from an area(s) corresponding to the conductive channel(s) and into or toward spaced-apart areas in which clustering of the proppant particles results in the formation of relatively less conductive areas, which clusters may correspond to pillars between opposing fracture faces upon closure. In embodiments, the movement of the proppant particles may be facilitated by the presence or introduction of an agglomerant aid such as a binding liquid, e.g., a hydrophobic liquid which may be introduced into the treatment fluid as an electrolysis product, in embodiments, or may be added using conventional treatment fluid mixing techniques; and the movement of the proppant particles may optionally be further facilitated by reduction of the viscosity of the treatment fluid, which may be instantaneous, gradual, or stagewise, e.g., by a viscosity-reducing component which may likewise be introduced into the treatment fluid as an electrolysis product, in embodiments, or may be added using conventional treatment fluid mixing techniques.

According to some embodiments herein, the open voids between the clusters within the proppant islands or other regions of proppant fill may be formed by injecting a treatment stage fluid, comprising a slurry of a solid particulate freely dispersed in fluid spaces around macrostructures suspended in a carrier fluid, into the fracture and aggregating the solid particulate in the fracture to form clusters at respective interfaces with adjacent macrostructures. According to some embodiments, the solid particulate comprises disaggregated proppant in a proppant-laden substage or pulse within the substage. According to some embodiments, the carrier fluid comprises fiber present in the fluid spaces around the macrostructures, e.g., gel balls, to stabilize the treatment stage fluid for the injection into the fracture.

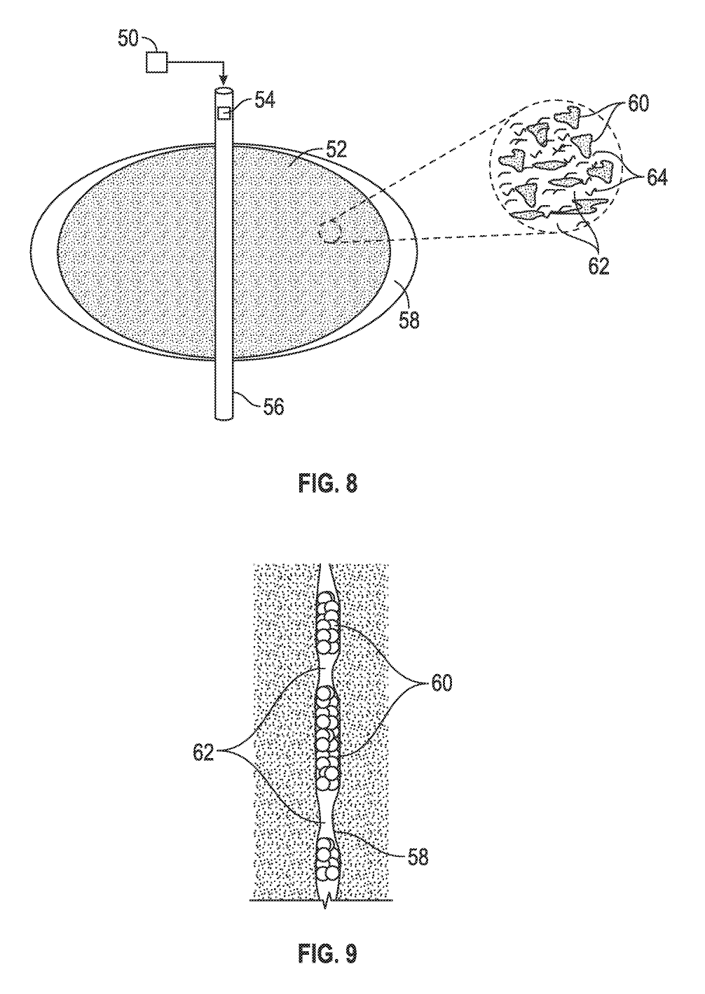

In some embodiments, the method comprises pumping a proppant laden fracturing fluid comprising a modulated electrolysis product(s) into a subterranean formation at pressure above a fracturing pressure of the formation. With reference to the system illustrated in FIG. 7, a pumping system 50 supplies a treatment fluid 52 through an electrolysis cell 54 and wellbore 56 and into the fracture 58. In this example, the treatment fluid 52 comprises proppant slurry comprising modulated viscosity-modifying electrolysis products, which initially fills the fracture 58 with a generally homogenous distribution of a propping agent. In some embodiments, the proppant slurry is destabilized, for example, prior to closure of the fracture 58, as illustrated in FIG. 8, resulting in the formation of proppant-rich clusters 60 separated by proppant-lean or proppant-free void spaces 62 between the clusters. Where the fracturing fluid 52 comprises macrostructures 64 such as fibers, these may dispose in the clusters 60, the void spaces 62, or a combination thereof. As illustrated in FIG. 9, upon closure of the fracture 58 and removal of any fibers, e.g., by hydrolysis or other degradative pathway, the clusters 60 prop open the fracture and fluid may readily flow through the conductive void spaces 62.

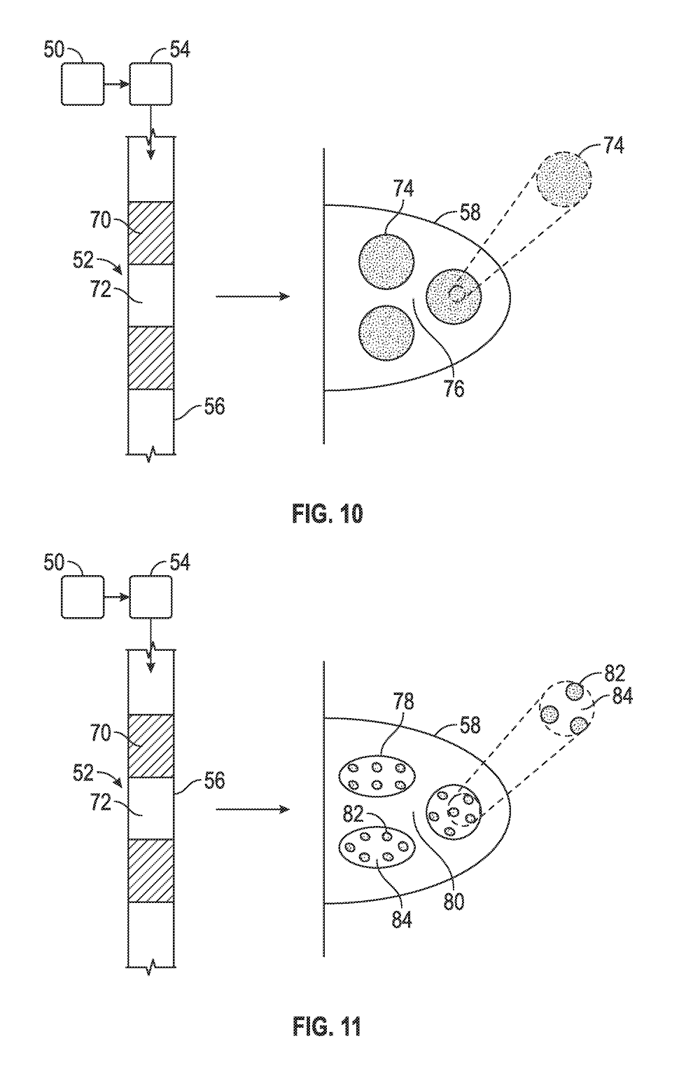

With reference to the system illustrated in FIG. 10, a pumping system 50 supplies a treatment fluid 52 through an electrolysis cell 54 to form modulated electrolysis product(s) in the treatment fluid supplied through the wellbore 56 to the fracture 58. In this system the treatment fluid 52 comprises alternating proppant-laden substages 70, with proppant-lean substages 72, which form proppant islands 74 in the fracture 58 corresponding to the proppant-laden substages 70 and channels 76 between the islands corresponding to the proppant-lean substages 72.

During the injection of the fracturing fluid, the pressure in the well or treatment zone thereof may be sufficiently maintained to keep the fracture 58 from closing before the islands 74 and channels 76 are formed, following which the fracture is closed on the proppant islands 74, which theoretically maintain the spacing between the opposing fracture faces for hydraulic conductivity. In this system, the channels 76 may be relatively wide since the fracture 58 may have a high rigidity such that fracture collapse does not occur, and thus a relatively high total volume of the proppant-lean substages 72 may be employed relative to that of the proppant-laden substages 70.

It should be noted when considering the relative volumes or other properties of the proppant-laden substages 70 relative to the proppant-lean substages 72, one generally refers only to the main substages, that is, any preceding pad or pre-pad stages as well as any following flush stages are not generally considered as being either a proppant-laden substage 70 or a proppant-lean substage 72 and may be excluded from the calculation. For example, the initial proppant-laden substage 70 is considered relative to the initial trailing proppant-lean substage 72, whereas the ultimate proppant-laden substage 70 may be considered relative to the immediately preceding proppant-lean substage 72, and the intermediate proppant-laden substages 70 may be considered relative to either the immediately preceding or immediately following proppant-lean substage 72.

In some embodiments according to the present disclosure as seen in FIG. 11, the volume of the proppant-laden substages 70 is as large as or larger than that of the adjacent proppant-lean substages 72, which results in a proportionately larger proppant coverage by the proppant islands 78 in the fracture 58. The open channels 80 between the islands 78 in some embodiments do not exceed the maximum allowable channel breadth to inhibit collapse of the fracture, while at the same time providing improved fracture propping capability, e.g., a relatively wider fracture, due to the higher propped region coverage, depending on the closure stress and strength of the fracture rock. That is to say, the open channels 80 may have a narrow breadth relative to FIG. 10, but may also have a greater width to maintain equivalent or improved conductivity, in some embodiments.

In addition, in some embodiments the islands 78 in FIG. 6 may be comprised of a plurality of proppant clusters 82 and open voids 84 to provide additional hydraulic conductivity through the islands 78. In some embodiments, these proppant clusters may be formed within the islands 78 by employing proppant-laden substages 70 which have an in-situ channelization functionality, e.g., a pulsed electrolysis product(s), pump rate and/or concentration of proppant or other component such that clusters 82 of the proppant are formed within the islands 78. For example, the proppant-laden substages 70 placed in the fracture 58 may include, activate, generate or release a trigger that induces channelization, any of which may be introduced into the treatment fluid in electrolytic cell 54; may be pulsed at different rates to induce clustering of the proppant within the islands 78; may contain alternating pulses comprising a substantially uniform distribution of one or more components in the alternate pulses and a heterogeneous distribution between alternate pulses of at least one other component, e.g., another component selected from the foam quality, solid particulate, fibers, anchorant, agglomerant, agglomerant aid, agglomerant aid activator, binding liquid, an induced settling trigger, viscous gel macrostructures, and combinations thereof; or the like, any of which may be introduced into the treatment fluid as it passes through the electrolytic cell 54.

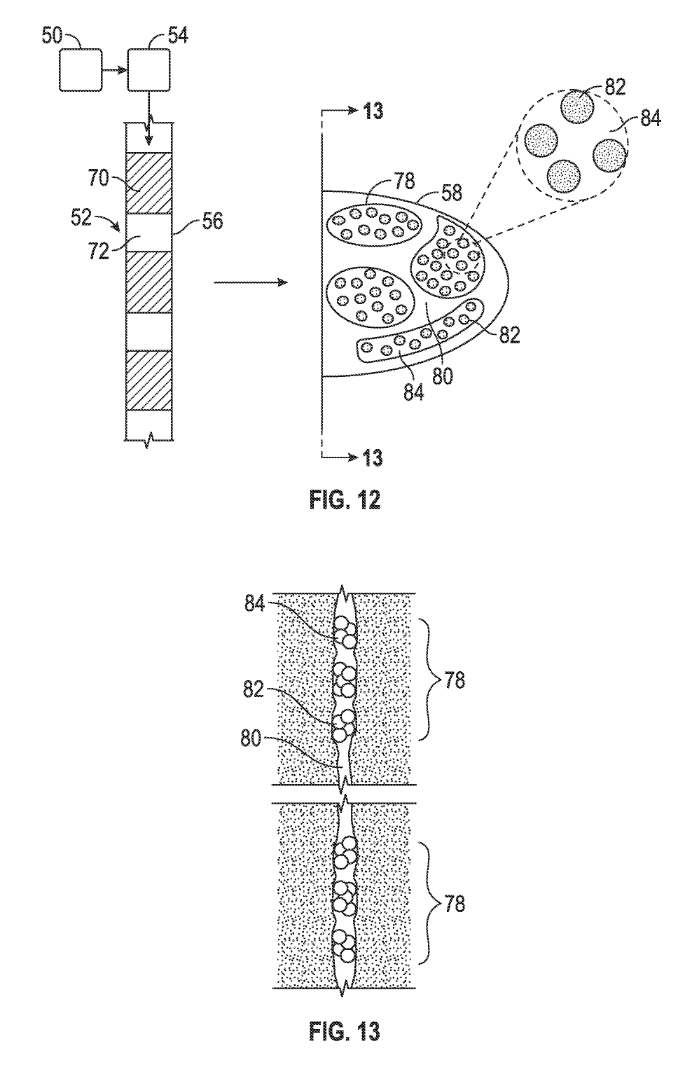

For some embodiments represented by FIGS. 12 and 13, the volume of the proppant-laden substages 70 is substantially larger than that of the adjacent proppant-lean substages 72, which results in a substantially larger proppant coverage by the proppant islands 78 in the fracture 58. For example, solid particulate-rich substages 70 and the solid particulate-lean substages 72 may have an overall volumetric ratio from 60:40 to 95:5, or from 70:30 to 90:10, or the like, e.g., 80:20. Or, the relative volumes of the proppant-laden substages 70 and proppant-lean substages 72 may be such that the ratio of the proppant coverage (area of the islands 78) to that of the channels 80 is from 60:40 to 95:5, or from 70:30 to 90:10, or the like, e.g., 80:20.

In some embodiments, the movement of proppant into clusters 82 may be facilitated by the presence of the electrolysis product(s) in the treatment fluid 52, especially in the proppant-laden substages 70 and/or the proppant-lean substages 72, such as, for example, by activation of an optional trigger to destabilize the proppant-laden substages 70 of the fracturing fluid and/or the regions of the proppant islands 78, such as, for example, a breaker or decrosslinking additive, which may be wholly or partially obtained by electrolysis of the treatment fluid, to at least partially reduce the localized viscosity of the fracturing fluid, e.g., from a viscosity corresponding to a crosslinked polymer to that of a linear polymer. Agglomerants such as fibers may optionally also settle in the fracture, e.g., at a slower rate than the proppant, which may result in some embodiments from the agglomerants having a specific gravity that is equal to or closer to that of the carrier fluid than that of the proppant. As one non-limiting example, the proppant may be sand with a specific gravity of 2.65, the agglomerants may be a localized fiber-laden region comprising fiber with a specific gravity of 1.1-1.5, e.g., polylactic acid fibers having a specific gravity of 1.25, and the carrier fluid may be aqueous with a specific gravity of 1-1.1, the carrier fluid may even have a specific gravity lower than 1 as may be the case with energized fluids or emulsions.

In some embodiments settling of the proppant may also be mediated by buoyancy imparted by gas, a binding liquid and/or fibers, any or all of which may be wholly or partially introduced into the treatment fluid by electrolysis, and which may have a specific gravity lower than that of the proppant, carrier liquid or other component. In this example, the lower specific gravity component may have a lower settling rate relative to the proppant. In other embodiments, agglomerants and/or anchorants may interact with either or both of the fracture faces, e.g. by friction or adhesion, which may similarly be mediated by the presence of any binding liquid in some embodiments, e.g., where the binding liquid has an affinity for the formation surface, and may have a density similar or dissimilar to that of the proppant, e.g., glass fibers may have a specific gravity greater than 2.

As a result of coalescence of proppant induced by differential settling rates in the carrying fluid according to some embodiments, the proppant may form clusters adjacent respective agglomerants, facilitated by the presence of any binding liquid, and settling is retarded. Further, in some embodiments, the agglomerants may be anchorants which are activated to form immobilized anchoring structures, which may be mediated by any binding liquid, to hold the clusters fast against the opposing surface(s) of the fracture.

In some embodiments, the method decreases the viscosity in the proppant-laden substages 70 of the fracturing fluid and/or the regions of the proppant islands 78 by employing a fracturing fluid comprising a crosslinked polymeric viscosifier for proppant placement, in one temporal stage to that of a linear gel, to promote proppant/agglomerant/binding liquid agglomeration for in-situ channelization, but without completely breaking the viscosity to facilitate anchoring prior to fracture closure, i.e., the formation or activation of anchors to inhibit complete settling of the proppant system to the floor of the fracture or proppant island.

The in-situ channelization concept is based on the creation of clusters, which in some embodiments may be anchored in the fracture within the proppant islands, to promote open voids within the islands. Anchors are materials designed to stay in place in the fracture, while clusters are the agglomeration of sand and any fiber, binding liquid or other materials that settle on top of the anchors after placement but before fracture closure. To initiate settling of the sand within the islands, a decrease in the fluid viscosity is implemented in some embodiments, e.g., by the formation of a breaker by electrolysis in some embodiments. In some embodiments, an acid or acid precursor may function as a de-crosslinker which may be mixed homogenously in the treatment fluid or the proppant-laden substages 70 thereof at the surface, or pulsed into the proppant-laden substages 70, and pumped down the wellbore and into the fracture. After placement, the de-crosslinker, which in some embodiments may be based on ester chemistry to release the acid by hydrolysis, is allowed to react with the crosslinked polymer to reduce its viscosity. After fracture closure, a breaker such as an oxidative breaker may break and/or, in the case of a partially broken or decrosslinked viscosifier, continue to more fully break the viscosifier to facilitate cleanup and reservoir production.

In-situ channelization in some embodiments promotes high conductivity through proppant islands 78 by the formation of open void spaces 84, relying on the settlement of the proppant and fibers on the anchors to form clusters 82, leaving high conductive void spaces 84 within the proppant islands 78 that are free of proppant surrounding the clusters 82. The rate of settlement of the proppant is related to the creation of clusters 82, where a high settling rate can lead to no anchors or clusters, whereas a slow settling rate can lead to no open voids 84 due to premature fracture closure. The settlement of the sand depends on the viscosity and specific gravity of the fluid, and also, according to embodiments herein, on the rate at which this viscosity decreases at the reservoir temperature.

In one representative example according to some embodiments, a gelling agent is guar based, crosslinked with borate or with a delayed crosslinker and the oil-in-water emulsion employs alkaline emulsifiers for stability, which may be destabilized by reducing the pH, e.g., where the electrolysis products comprise an acid, such as hypochlorite. In some embodiments, the crosslinkers are used to create highly viscous gels comprising a stable oil-in-water emulsion at a pH between 8 and 12. In some embodiments, esters are used as dual functionality demulsifiers and decrosslinkers, since at high reservoir temperatures some esters can undergo hydrolysis and form carboxylic acids, lowering the pH of the fluid and thus destabilizing the emulsion to release the oil phase while simultaneously deactivating the borate or other crosslinker and thereby decrosslinking the fluid to improve mobility of the agglomerants, anchorants, channelization aids and/or proppants.

A system used to implement the fracture treatment may include a pump system comprising one or more pumps to supply the treatment fluid to the wellbore and fracture. In embodiments, the wellbore may include a substantially horizontal portion, which may be cased or completed open hole, wherein the fracture is transversely or longitudinally oriented and thus generally vertical or sloped with respect to horizontal. A mixing station in some embodiments may be provided at the surface to supply a mixture of carrier fluid, proppant, agglomerant, agglomerant aid, agglomerant aid activator, viscosifier, decrosslinking agent, etc., which may for example be an optionally stabilized concentrated blend slurry (CBS) to allow reliable control of the proppant concentration, any fiber, agglomerant aid, etc., which may for example be a concentrated masterbatch to allow reliable control of the concentration of the fiber, proppant, agglomerant aid, etc., and any other additives which may be supplied in any order, such as, for example, other viscosifiers, loss control agents, friction reducers, clay stabilizers, biocides, crosslinkers, breakers, breaker aids, corrosion inhibitors, and/or proppant flowback control additives, or the like. In embodiments, the system comprises an electrolytic cell in the flow path of the treatment fluid as described herein which may introduce any of the treatment fluid components as an electrolysis product(s).

In some embodiments, concentrations of one or more additives, including the proppants, fibers, agglomerant aid, or the like, to the fracturing fluid may be alternated. For example agglomerants/agglomerant aids may be alternatingly added, or a higher agglomerant/agglomerant aid concentration may be added, and/or a rheology-modifying electrolysis product may be alternatingly introduced by current modulation to an in-line electrolysis cell, to form slugs of treatment fluid in which agglomeration and/or settling is promoted or inhibited, which may accumulate clusters during channelization, but which may be completely degraded after fracture closure to widen open voids or form additional open voids. Two or more additives (including agglomerants and/or agglomerant aids and/or electrolysis product(s)) may also be alternated independently in pulses within the proppant-laden substages.

The well may if desired also be provided with a shut in valve to maintain pressure in the wellbore and fracture, a flow-back/production line to flow back or produce fluids either during or post-treatment, as well as any conventional wellhead equipment.

If desired in some embodiments, the pumping schedule for the proppant-laden substages may be employed according to the alternating-proppant loading technology disclosed in U.S. Patent Application Publication No. US 2008/0135242, which is hereby incorporated herein by reference.

In some embodiments, a treatment slurry stage, e.g., the proppant-laden substages thereof, has a continuous concentration of a first solid particulate, e.g., proppant, and a discontinuous concentration of an additive or electrolysis product(s) that facilitates either clustering of the first solid particulate in the islands, or anchoring of the clusters in the islands, or a combination thereof, to form clusters of the first solid particulate to prop open the fracture upon closure. As used herein, “anchorant” refers to a material, a precursor material, or a mechanism, that inhibits movement such as settling, or preferably stops movement, of particulates or clusters of particulates in a fracture, whereas an “anchor” refers to an anchorant that is active or activated to inhibit or stop the movement. In some embodiments, the agglomerant may be an anchorant that may comprise a material, such as fibers, flocs, flakes, discs, rods, stars, etc., for example, which may be heterogeneously distributed in the island regions of the fracture and have a different movement rate, and/or cause some of the first solid particulate to have a different movement rate, which may be faster or preferably slower with respect to the settling of the first solid particulate and/or clusters. As used herein, the term “flocs” includes both flocculated colloids and colloids capable of forming flocs in the treatment slurry stage.

In some embodiments, the agglomerant/anchorant may adhere to one or both opposing surfaces of the fracture to stop movement of a proppant particle cluster and/or to provide immobilized structures upon which proppant or proppant cluster(s) may accumulate. In some embodiments, the agglomerants/anchors may adhere to each other to facilitate consolidation, stability and/or strength of the formed clusters, which adherence may be mediated by the presence or generation of any binding liquid. Adherence of the agglomerants to each other and/or to the fracture surface may be promoted by a binding liquid in some embodiments.

In some embodiments, the anchorant may comprise a continuous concentration of a first anchorant component and a discontinuous concentration of a second anchorant component, e.g., where the first and second anchorant components may react or combine to form the anchor as in a fiber/binding liquid system, a two-reactant system, a catalyst/reactant system, a pH-sensitive reactant/pH modifier system (which may be or include the decrosslinker), or the like.

In some embodiments, the anchorant may form boundaries for particulate movement, e.g., lower boundaries for particulate settling.

In some embodiments, the conductive channels extend in fluid communication from adjacent a face of the formation away from the wellbore to or to near the wellbore, e.g., to facilitate the passage of fluid between the wellbore and the formation, such as in the production of reservoir fluids and/or the injection of fluids into the formation matrix. As used herein, “near the wellbore” refers to conductive channels coextensive along a majority of a length of the fracture terminating at a permeable matrix between the conductive channels and the wellbore, e.g., where the region of the fracture adjacent the wellbore is filled with a permeable solids pack as in a high conductive proppant tail-in stage, gravel packing or the like.

In some embodiments, the proppant islands are channelized by injecting into a fracture in the formation at a continuous rate the proppant-laden substage with a continuous first solid particulate concentration; and while maintaining the continuous rate and first solid particle concentration during injection of the proppant-laden substage, successively alternating concentration modes of an anchorant, such as fiber, in pulses between a plurality of relatively anchorant-rich modes and a plurality of anchorant-lean modes within the injected treatment fluid stage.

In some embodiments, the injection of the proppant-laden substages forms a homogenous region within the proppant islands of continuously uniform distribution of the first solid particulate. In some embodiments, the alternation of pulses of the concentration of the agglomerant and/or agglomerant aid forms heterogeneous areas within the proppant islands comprising agglomerant/agglomerant aid-rich areas and agglomerant/agglomerant aid-lean areas.

In some embodiments, the agglomerant may comprise a degradable material. In some embodiments, the agglomerant is selected from the group consisting of polylactic acid (PLA), polyglycolic acid (PGA), polyethylene terephthalate (PET), polyester, polyamide, polycaprolactam and polylactone, poly(butylene succinate, polydioxanone, glass, ceramics, carbon (including carbon-based compounds), elements in metallic form, metal alloys, wool, basalt, acrylic, polyethylene, polypropylene, novoloid resin, polyphenylene sulfide, polyvinyl chloride, polyvinylidene chloride, polyurethane, polyvinyl alcohol, polybenzimidazole, polyhydroquinone-diimidazopyridine, poly(p-phenylene-2,6-benzobisoxazole), rayon, cotton, or other natural fibers, rubber, sticky fiber, or a combination thereof. In some embodiments the agglomerant may comprise acrylic fiber. In some embodiments the agglomerant may comprise mica.

In some embodiments, the agglomerant is present in the agglomerant-laden stages or pulses of the proppant-laden substages in an amount of less than 5 vol %. All individual values and subranges from less than 5 vol % are included and disclosed herein. For example, the amount of agglomerant may be from 0.05 vol % less than 5 vol %, or less than 1 vol %, or less than 0.5 vol %. The agglomerant may be present in an amount from 0.5 vol % to 1.5 vol %, or in an amount from 0.01 vol % to 0.5 vol %, or in an amount from 0.05 vol % to 0.5 vol %.

In further embodiments, the agglomerant may comprise a fiber with a length from 1 to 50 mm, or more specifically from 1 to 10 mm, and a diameter of from 1 to 50 microns, or, more specifically from 1 to 20 microns. All values and subranges from 1 to 50 mm are included and disclosed herein. For example, the fiber agglomerant length may be from a lower limit of 1, 3, 5, 7, 9, 19, 29 or 49 mm to any higher upper limit of 2, 4, 6, 8, 10, 20, 30 or 50 mm. The fiber agglomerant length may range from 1 to 50 mm, or from 1 to 10 mm, or from 1 to 7 mm, or from 3 to 10 mm, or from 2 to 8 mm. All values from 1 to 50 microns are included and disclosed herein. For example, the fiber agglomerant diameter may be from a lower limit of 1, 4, 8, 12, 16, 20, 30, 40, or 49 microns to an upper limit of 2, 6, 10, 14, 17, 22, 32, 42 or 50 microns. The fiber agglomerant diameter may range from 1 to 50 microns, or from 10 to 50 microns, or from 1 to 15 microns, or from 2 to 17 microns.

In further embodiments, the agglomerant may be fiber selected from the group consisting of polylactic acid (PLA), polyester, polycaprolactam, polyamide, polyglycolic acid, polyterephthalate, cellulose, wool, basalt, glass, rubber, or a combination thereof.

In further embodiments, the agglomerant may comprise a fiber with a length from 0.001 to 1 mm and a diameter of from 50 nanometers (nm) to 10 microns. All individual values from 0.001 to 1 mm are disclosed and included herein. For example, the agglomerant fiber length may be from a lower limit of 0.001, 0.01, 0.1 or 0.9 mm to any higher upper limit of 0.009, 0.07, 0.5 or 1 mm. All individual values from 50 nanometers to 10 microns are included and disclosed herein. For example, the fiber agglomerant diameter may range from a lower limit of 50, 60, 70, 80, 90, 100, or 500 nanometers to an upper limit of 500 nanometers, 1 micron, or 10 microns.

In some embodiments, the agglomerant may comprise an expandable material, such as, for example, swellable elastomers, temperature expandable particles, Examples of oil swellable elastomers include butadiene based polymers and copolymers such as styrene butadiene rubber (SBR), styrene butadiene block copolymers, styrene isoprene copolymer, acrylate elastomers, neoprene elastomers, nitrile elastomers, vinyl acetate copolymers and blends of EVA, and polyurethane elastomers. Examples of water and brine swellable elastomers include maleic acid grafted styrene butadiene elastomers and acrylic acid grafted elastomers. Examples of temperature expandable particles include metals and gas filled particles that expand more when the particles are heated relative to silica sand. In some embodiments, the expandable metals can include a metal oxide of Ca, Mn, Ni, Fe, etc. that reacts with the water to generate a metal hydroxide which has a lower density than the metal oxide, i.e., the metal hydroxide occupies more volume than the metal oxide thereby increasing the volume occupied by the particle. Further examples of swellable inorganic materials can be found in U.S. Application Publication Number US 20110098202, which is hereby incorporated by reference in its entirety. An example for gas filled material is EXPANCEL™ microspheres that are manufactured by and commercially available from Akzo Nobel of Chicago, Ill. These microspheres contain a polymer shell with gas entrapped inside. When these microspheres are heated the gas inside the shell expands and increases the size of the particle. The diameter of the particle can increase 4 times which could result in a volume increase by a factor of 64.

In some embodiments the agglomerants may be gel bodies such as balls or blobs made with a viscosifier, such as for example, a water soluble polymer such as polysaccharide like hydroxyethylcellulose (HEC) and/or guar, copolymers of polyacrylamide and their derivatives, and the like, e.g., at a concentration of 1.2 to 24 g/L (10 to 200 ppt where “ppt” is pounds per 1000 gallons of fluid), or a viscoelastic surfactant (VES). The polymer in some embodiments may be crosslinked with a crosslinker such as metal, e.g., calcium or borate. The gel bodies may further optionally comprise fibers and/or particulates dispersed in an internal phase. The gel bodies may be made from the same or different polymer and/or crosslinker as the continuous crosslinked polymer phase, but may have a different viscoelastic characteristic or morphology.

In some embodiments, a system to produce reservoir fluids comprises the wellbore and the fracture resulting from any of the fracturing methods disclosed herein.

The following discussion is based on specific examples according to some embodiments wherein the first particulate comprises proppant and the agglomerant or anchor, where present, comprises fiber. In some specific embodiments illustrated below, the wellbore is oriented horizontally and the fracture is generally vertical, however, the disclosure herein is not limited to this specific configuration.

As used herein, the terms “treatment fluid” or “wellbore treatment fluid” are inclusive of “fracturing fluid” or “treatment slurry” and should be understood broadly. These may be or include a liquid, a solid, a gas, and combinations thereof, as will be appreciated by those skilled in the art. A treatment fluid may take the form of a solution, an emulsion, an energized fluid (including foam), slurry, or any other form as will be appreciated by those skilled in the art.

As used herein, “slurry” refers to an optionally flowable mixture of particles dispersed in a fluid carrier. The terms “flowable” or “pumpable” or “mixable” are used interchangeably herein and refer to a fluid or slurry that has either a yield stress or low-shear (5.11 s⁻¹) viscosity less than 1000 Pa and a dynamic apparent viscosity of less than 10 Pa-s (10,000 cP) at a shear rate 170 s⁻¹, where yield stress, low-shear viscosity and dynamic apparent viscosity are measured at a temperature of 25° C. unless another temperature is specified explicitly or in context of use.

“Viscosity” as used herein unless otherwise indicated refers to the apparent dynamic viscosity of a fluid at a temperature of 25° C. and shear rate of 170 s⁻¹.

“Treatment fluid” or “fluid” (in context) refers to the entire treatment fluid, including any proppant, subproppant particles, liquid, gas etc. “Whole fluid,” “total fluid” and “base fluid” are used herein to refer to the fluid phase plus any subproppant particles dispersed therein, but exclusive of proppant particles. “Carrier,” “fluid phase” or “liquid phase” refer to the fluid or liquid that is present, which may comprise a continuous phase and optionally one or more discontinuous gas or liquid fluid phases dispersed in the continuous phase, including any solutes, thickeners or colloidal particles only, exclusive of other solid phase particles; reference to “water” in the slurry refers only to water and excludes any gas, liquid or solid particles, solutes, thickeners, colloidal particles, etc.; reference to “aqueous phase” refers to a carrier phase comprised predominantly of water, which may be a continuous or dispersed phase. As used herein the terms “liquid” or “liquid phase” encompasses both liquids per se and supercritical fluids, including any solutes dissolved therein.

The term “dispersion” means a mixture of one substance dispersed in another substance, and may include colloidal or non-colloidal systems. As used herein, “emulsion” generally means any system with one liquid phase dispersed in another immiscible liquid phase, and may apply to oil-in-water and water-in-oil emulsions. Invert emulsions refer to any water-in-oil emulsion in which oil is the continuous or external phase and water is the dispersed or internal phase.

As used herein unless otherwise specified, as described in further detail herein, particle size and particle size distribution (PSD) mode refer to the median volume averaged size. The median size used herein may be any value understood in the art, including for example and without limitation a diameter of roughly spherical particulates. In an embodiment, the median size may be a characteristic dimension, which may be a dimension considered most descriptive of the particles for specifying a size distribution range.

As used herein, a “water soluble polymer” refers to a polymer which has a water solubility of at least 5 wt % (0.5 g polymer in 9.5 g water) at 25° C.

The measurement or determination of the viscosity of the liquid phase (as opposed to the treatment fluid or base fluid) may be based on a direct measurement of the solids-free liquid, or a calculation or correlation based on a measurement(s) of the characteristics or properties of the liquid containing the solids, or a measurement of the solids-containing liquid using a technique where the determination of viscosity is not affected by the presence of the solids. As used herein, solids-free for the purposes of determining the viscosity of the liquid phase means in the absence of non-colloidal particles larger than 1 micron such that the particles do not affect the viscosity determination, but in the presence of any submicron or colloidal particles that may be present to thicken and/or form a gel with the liquid, i.e., in the presence of ultrafine particles that can function as a thickening agent. In some embodiments, a “low viscosity liquid phase” means a viscosity less than about 300 mPa-s measured without any solids greater than 1 micron at 170 s⁻¹ and 25° C.

In some embodiments, the treatment fluid may include a continuous fluid phase, also referred to as an external phase, and a discontinuous phase(s), also referred to as an internal phase(s), which may be a fluid (liquid or gas) in the case of an emulsion, foam or energized fluid, or which may be a solid in the case of a slurry. The continuous fluid phase, also referred to herein as the carrier fluid or comprising the carrier fluid, may be any matter that is substantially continuous under a given condition. Examples of the continuous fluid phase include, but are not limited to, water, hydrocarbon, gas (e.g., nitrogen or methane), liquefied gas (e.g., propane, butane, or the like), etc., which may include solutes, e.g. the fluid phase may be a brine, and/or may include a brine or other solution(s). In some embodiments, the fluid phase(s) may optionally include a viscosifying and/or yield point agent and/or a portion of the total amount of viscosifying and/or yield point agent present. Some non-limiting examples of the fluid phase(s) include hydratable gels and mixtures of hydratable gels (e.g. gels containing polysaccharides such as guars and their derivatives, xanthan and diutan and their derivatives, hydratable cellulose derivatives such as hydroxyethylcellulose, carboxymethylcellulose and others, polyvinyl alcohol and its derivatives, other hydratable polymers, colloids, etc.), a cross-linked hydratable gel, a viscosified acid (e.g. gel-based), an emulsified acid (e.g. oil outer phase), an energized fluid (e.g., an N₂ or CO₂ based foam), a viscoelastic surfactant (VES) viscosified fluid, and an oil-based fluid including a gelled, foamed, or otherwise viscosified oil.

The discontinuous phase if present in the treatment fluid may be any particles (including fluid droplets) that are suspended or otherwise dispersed in the continuous phase in a disjointed manner. In this respect, the discontinuous phase can also be referred to, collectively, as “particle” or “particulate” which may be used interchangeably. As used herein, the term “particle” should be construed broadly. For example, in some embodiments, the particle(s) of the current application are solid such as proppant, sands, ceramics, crystals, salts, etc.; however, in some other embodiments, the particle(s) can be liquid, gas, foam, emulsified droplets, etc. Moreover, in some embodiments, the particle(s) of the current application are substantially stable and do not change shape or form over an extended period of time, temperature, or pressure; in some other embodiments, the particle(s) of the current application are degradable, expandable, swellable, dissolvable, deformable, meltable, sublimeable, or otherwise capable of being changed in shape, state, or structure.

In an embodiment, the particle(s) is substantially round and spherical. In an embodiment, the particle(s) is not substantially spherical and/or round, e.g., it can have varying degrees of sphericity and roundness, according to the API RP-60 sphericity and roundness index. For example, the particle(s) used as anchorants or otherwise may have an aspect ratio of more than 2, 3, 4, 5 or 6. Examples of such non-spherical particles include, but are not limited to, fibers, flocs, flakes, discs, rods, stars, etc. All such variations should be considered within the scope of the current application.

Introducing high-aspect ratio particles into the treatment fluid, e.g., particles having an aspect ratio of at least 6, represents additional or alternative embodiments for stabilizing the treatment fluid and inhibiting settling during proppant placement, which can be removed, for example by dissolution or degradation into soluble degradation products. Examples of such non-spherical particles include, but are not limited to, fibers, flocs, flakes, discs, rods, stars, etc., as described in, for example, U.S. Pat. No. 7,275,596, US20080196896, which are hereby incorporated herein by reference. In an embodiment, introducing ciliated or coated proppant into the treatment fluid may also stabilize or help stabilize the treatment fluid or regions thereof. Proppant or other particles coated with a hydrophilic polymer can make the particles behave like larger particles and/or more tacky particles in an aqueous medium. The hydrophilic coating on a molecular scale may resemble ciliates, i.e., proppant particles to which hairlike projections have been attached to or formed on the surfaces thereof. Herein, hydrophilically coated proppant particles are referred to as “ciliated or coated proppant.” Hydrophilically coated proppants and methods of producing them are described, for example, in WO 2011-050046, U.S. Pat. No. 5,905,468, U.S. Pat. No. 8,227,026 and U.S. Pat. No. 8,234,072, which are hereby incorporated herein by reference.

In an embodiment, the particles may be multimodal. As used herein multimodal refers to a plurality of particle sizes or modes which each has a distinct size or particle size distribution, e.g., proppant and fines. As used herein, the terms distinct particle sizes, distinct particle size distribution, or multi-modes or multimodal, mean that each of the plurality of particles has a unique volume-averaged particle size distribution (PSD) mode. That is, statistically, the particle size distributions of different particles appear as distinct peaks (or “modes”) in a continuous probability distribution function. For example, a mixture of two particles having normal distribution of particle sizes with similar variability is considered a bimodal particle mixture if their respective means differ by more than the sum of their respective standard deviations, and/or if their respective means differ by a statistically significant amount. In an embodiment, the particles contain a bimodal mixture of two particles; in an embodiment, the particles contain a trimodal mixture of three particles; in an embodiment, the particles contain a tetramodal mixture of four particles; in an embodiment, the particles contain a pentamodal mixture of five particles, and so on. Representative references disclosing multimodal particle mixtures include U.S. Pat. No. 5,518,996, U.S. Pat. No. 7,784,541, U.S. Pat. No. 7,789,146, U.S. Pat. No. 8,008,234, U.S. Pat. No. 8,119,574, U.S. Pat. No. 8,210,249, US 2010/0300688, US 2012/0000641, US 2012/0138296, US 2012/0132421, US 2012/0111563, WO 2012/054456, US 2012/0305245, US 2012/0305254, WO2013085412 and US 20130233542, each of which are hereby incorporated herein by reference.

“Solids” and “solids volume” refer to all solids present in the slurry, including proppant and subproppant particles, including particulate thickeners such as colloids and submicron particles. “Solids-free” and similar terms generally exclude proppant and subproppant particles, except particulate thickeners such as colloids for the purposes of determining the viscosity of a “solids-free” fluid.

“Proppant” refers to particulates that are used in well work-overs and treatments, such as hydraulic fracturing operations, to hold fractures open following the treatment. In some embodiments, the proppant may be of a particle size mode or modes in the slurry having a weight average mean particle size greater than or equal to about 100 microns, e.g., 140 mesh particles correspond to a size of 105 microns. In further embodiments, the proppant may comprise particles or aggregates made from particles with size from 0.001 to 1 mm. All individual values from 0.001 to 1 mm are disclosed and included herein. For example, the solid particulate size may be from a lower limit of 0.001, 0.01, 0.1 or 0.9 mm to an upper limit of 0.009, 0.07, 0.5 or 1 mm. Here particle size is defined is the largest dimension of the grain of said particle.

“Gravel” refers to particles used in gravel packing, and the term is synonymous with proppant as used herein. “Sub-proppant” or “subproppant” refers to particles or particle size or mode (including colloidal and submicron particles) having a smaller size than the proppant mode(s); references to “proppant” exclude subproppant particles and vice versa. In an embodiment, the sub-proppant mode or modes each have a weight average mean particle size less than or equal to about one-half of the weight average mean particle size of a smallest one of the proppant modes, e.g., a suspensive/stabilizing mode.

The proppant, when present, can be naturally occurring materials, such as sand grains. The proppant, when present, can also be man-made or specially engineered, such as coated (including resin-coated) sand, modulus of various nuts, high-strength ceramic materials like sintered bauxite, etc. In some embodiments, the proppant of the current application, when present, has a density greater than 2.45 g/mL, e.g., 2.5-2.8 g/mL, such as sand, ceramic, sintered bauxite or resin coated proppant. In some embodiments, the proppant of the current application, when present, has a density greater than or equal to 2.8 g/mL, and/or the treatment fluid may comprise an apparent specific gravity less than 1.5, less than 1.4, less than 1.3, less than 1.2, less than 1.1, or less than 1.05, less than 1, or less than 0.95, for example. In some embodiments a relatively large density difference between the proppant and carrier fluid may enhance proppant settling during the clustering phase, for example.

In some embodiments, the proppant of the current application, when present, has a density less than or equal to 2.45 g/mL, such as light/ultralight proppant from various manufacturers, e.g., hollow proppant. In some embodiments, the treatment fluid comprises an apparent specific gravity greater than 1.3, greater than 1.4, greater than 1.5, greater than 1.6, greater than 1.7, greater than 1.8, greater than 1.9, greater than 2, greater than 2.1, greater than 2.2, greater than 2.3, greater than 2.4, greater than 2.5, greater than 2.6, greater than 2.7, greater than 2.8, greater than 2.9, or greater than 3. In some embodiments where the proppant may be buoyant, i.e., having a specific gravity less than that of the carrier fluid, the term “settling” shall also be inclusive of upward settling or floating.

“Stable” or “stabilized” or similar terms refer to a concentrated blend slurry (CBS) wherein gravitational settling of the particles is inhibited such that no or minimal free liquid is formed, and/or there is no or minimal rheological variation among strata at different depths in the CBS, and/or the slurry may generally be regarded as stable over the duration of expected CBS storage and use conditions, e.g., a CBS that passes a stability test or an equivalent thereof. In an embodiment, stability can be evaluated following different settling conditions, such as for example static under gravity alone, or dynamic under a vibratory influence, or dynamic-static conditions employing at least one dynamic settling condition followed and/or preceded by at least one static settling condition.

The static settling test conditions can include gravity settling for a specified period, e.g., 24 hours, 48 hours, 72 hours, or the like, which are generally referred to with the respective shorthand notation “24 h-static”, “48 h-static” or “72 h static”. Dynamic settling test conditions generally indicate the vibratory frequency and duration, e.g., 4 h@15 Hz (4 hours at 15 Hz), 8 h@5 Hz (8 hours at 5 Hz), or the like. Dynamic settling test conditions are at a vibratory amplitude of 1 mm vertical displacement unless otherwise indicated. Dynamic-static settling test conditions will indicate the settling history preceding analysis including the total duration of vibration and the final period of static conditions, e.g., 4 h@15 Hz/20 h-static refers to 4 hours vibration followed by 20 hours static, or 8 h@15 Hz/10 d-static refers to 8 hours total vibration, e.g., 4 hours vibration followed by 20 hours static followed by 4 hours vibration, followed by 10 days of static conditions. In the absence of a contrary indication, the designation “8 h@15 Hz/10d-static” refers to the test conditions of 4 hours vibration, followed by 20 hours static followed by 4 hours vibration, followed by 10 days of static conditions. In the absence of specified settling conditions, the settling condition is 72 hours static. The stability settling and test conditions are at 25° C. unless otherwise specified.

As used herein, a concentrated blend slurry (CBS) may meet at least one of the following conditions:
(1) the slurry has a low-shear viscosity equal to or greater than 1 Pa-s (5.11 s⁻¹, 25° C.);
(2) the slurry has a Herschel-Bulkley (including Bingham plastic) yield stress (as determined in the manner described herein) equal to or greater than 1 Pa; or
(3) the largest particle mode in the slurry has a static settling rate less than 0.01 mm/hr; or
(4) the depth of any free fluid at the end of a 72-hour static settling test condition or an 8 h@15 Hz/10d-static dynamic settling test condition (4 hours vibration followed by 20 hours static followed by 4 hours vibration followed finally by 10 days of static conditions) is no more than 2% of total depth; or
(5) the apparent dynamic viscosity (25° C., 170 s⁻¹) across column strata after the 72-hour static settling test condition or the 8 h@15 Hz/10d-static dynamic settling test condition is no more than +/−20% of the initial dynamic viscosity; or
(6) the slurry solids volume fraction (SVF) across the column strata below any free water layer after the 72-hour static settling test condition or the 8 h@15 Hz/10d-static dynamic settling test condition is no more than 5% greater than the initial SVF; or
(7) the density across the column strata below any free water layer after the 72-hour static settling test condition or the 8 h@15 Hz/10d-static dynamic settling test condition is no more than 1% of the initial density.

In some embodiments, the concentrated blend slurry comprises at least one of the following stability indicia: (1) an SVF of at least 0.4 up to SVF=PVF; (2) a low-shear viscosity of at least 1 Pa-s (5.11 s⁻¹, 25° C.); (3) a yield stress (as determined herein) of at least 1 Pa; (4) an apparent viscosity of at least 50 mPa-s (170 s⁻¹, 25° C.); (5) a multimodal solids phase; (6) a solids phase having a PVF greater than 0.7; (7) a viscosifier selected from viscoelastic surfactants, in an amount ranging from 0.01 up to 7.2 g/L (60 ppt), and hydratable gelling agents in an amount ranging from 0.01 up to 4.8 g/L (40 ppt) based on the volume of fluid phase; (8) colloidal particles; (9) a particle-fluid density delta less than 1.6 g/mL, (e.g., particles having a specific gravity less than 2.65 g/mL, carrier fluid having a density greater than 1.05 g/mL or a combination thereof); (10) particles having an aspect ratio of at least 6; (11) ciliated or coated proppant; and (12) combinations thereof.

In an embodiment, the concentrated blend slurry is formed (stabilized) by at least one of the following slurry stabilization operations: (1) introducing sufficient particles into the slurry or treatment fluid to increase the SVF of the treatment fluid to at least 0.4; (2) increasing a low-shear viscosity of the slurry or treatment fluid to at least 1 Pa-s (5.11 s⁻¹, 25° C.); (3) increasing a yield stress of the slurry or treatment fluid to at least 1 Pa; (4) increasing apparent viscosity of the slurry or treatment fluid to at least 50 mPa-s (170 s⁻¹, 25° C.); (5) introducing a multimodal solids phase into the slurry or treatment fluid; (6) introducing a solids phase having a PVF greater than 0.7 into the slurry or treatment fluid; (7) introducing into the slurry or treatment fluid a viscosifier selected from viscoelastic surfactants, e.g., in an amount ranging from 0.01 up to 7.2 g/L (60 ppt), and hydratable gelling agents, e.g., in an amount ranging from 0.01 up to 4.8 g/L (40 ppt) based on the volume of fluid phase; (8) introducing colloidal particles into the slurry or treatment fluid; (9) reducing a particle-fluid density delta to less than 1.6 g/mL (e.g., introducing particles having a specific gravity less than 2.65 g/mL, carrier fluid having a density greater than 1.05 g/mL or a combination thereof); (10) introducing particles into the slurry or treatment fluid having an aspect ratio of at least 6; (11) introducing ciliated or coated proppant into slurry or treatment fluid; and (12) combinations thereof. The slurry stabilization operations may be separate or concurrent, e.g., introducing a single viscosifier may also increase low-shear viscosity, yield stress, apparent viscosity, etc., or alternatively or additionally with respect to a viscosifier, separate agents may be added to increase low-shear viscosity, yield stress and/or apparent viscosity.

Increasing carrier fluid viscosity in a Newtonian fluid also proportionally increases the resistance of the carrier fluid motion. In some embodiments, the carrier fluid has a lower limit of apparent dynamic viscosity, determined at 170 s⁻¹ and 25° C., of at least about 10 mPa-s, or at least about 25 mPa-s, or at least about 50 mPa-s, or at least about 75 mPa-s, or at least about 100 mPa-s, or at least about 150 mPa-s, or at least about 300 mPa-s, or at least about 500 mPa-s. A disadvantage of increasing the viscosity is that as the viscosity increases, the friction pressure for pumping the slurry generally increases as well. In some embodiments, the fluid carrier has an upper limit of apparent dynamic viscosity, determined at 170 s⁻¹ and 25° C., of less than about 1000 mPa-s, or less than about 500 mPa-s, or less than about 300 mPa-s, or less than about 150 mPa-s, or less than about 100 mPa-s, or less than about 50 mPa-s. In an embodiment, the fluid phase viscosity ranges from any lower limit to any higher upper limit.

In some embodiments, an agent may both viscosify and impart yield stress characteristics, and in further embodiments may also function as a friction reducer to reduce friction pressure losses in pumping the treatment fluid. In an embodiment, the liquid phase is essentially free of viscosifier or comprises a viscosifier in an amount ranging from 0.01 up to 12 g/L (0.08-100 ppt) of the fluid phase. The viscosifier can be a viscoelastic surfactant (VES) or a hydratable gelling agent such as a polysaccharide, which may be crosslinked. When using viscosifiers and/or yield stress fluids, proppant settling in some embodiments may be triggered by breaking the fluid using a breaker(s). In some embodiments, the slurry is stabilized for storage and/or pumping or other use at the surface conditions and proppant transport and placement, and settlement triggering is achieved downhole at a later time prior to fracture closure, which may be at a higher temperature, e.g., for some formations, the temperature difference between surface and downhole can be significant and useful for triggering degradation of the viscosifier, any stabilizing particles (e.g., subproppant particles) if present, a yield stress agent or characteristic, and/or a activation of a breaker. Thus in some embodiments, breakers that are either temperature sensitive or time sensitive, either through delayed action breakers or delay in mixing the breaker into the slurry to initiate destabilization of the slurry and/or proppant settling, can be useful.

In embodiments, the fluid may include leakoff control agents, such as, for example, latex dispersions, water soluble polymers, submicron particulates, particulates with an aspect ratio higher than 1, or higher than 6, combinations thereof and the like, such as, for example, crosslinked polyvinyl alcohol microgel. The fluid loss agent can be, for example, a latex dispersion of polyvinylidene chloride, polyvinyl acetate, polystyrene-co-butadiene; a water soluble polymer such as hydroxyethylcellulose (HEC), guar, copolymers of polyacrylamide and their derivatives; particulate fluid loss control agents in the size range of 30 nm to 1 micron, such as γ-alumina, colloidal silica, CaCO3, SiO2, bentonite etc.; particulates with different shapes such as glass fibers, flocs, flakes, films; and any combination thereof or the like. Fluid loss agents can if desired also include or be used in combination with acrylamido-methyl-propane sulfonate polymer (AMPS). In an embodiment, the leak-off control agent comprises a reactive solid, e.g., a hydrolyzable material such as PGA, PLA or the like; or it can include a soluble or solubilizable material such as a wax, an oil-soluble resin, or another material soluble in hydrocarbons, or calcium carbonate or another material soluble at low pH; and so on. In an embodiment, the leak-off control agent comprises a reactive solid selected from ground quartz, oil soluble resin, degradable rock salt, clay, zeolite or the like. In other embodiments, the leak-off control agent comprises one or more of magnesium hydroxide, magnesium carbonate, magnesium calcium carbonate, calcium carbonate, aluminum hydroxide, calcium oxalate, calcium phosphate, aluminum metaphosphate, sodium zinc potassium polyphosphate glass, and sodium calcium magnesium polyphosphate glass, or the like. The treatment fluid may also contain colloidal particles, such as, for example, colloidal silica, which may function as a loss control agent, gellant and/or thickener.

In embodiments, the proppant-containing treatment fluid may comprise from 0.06 or 0.12 g of proppant per mL of treatment fluid (corresponding to 0.5 or 1 ppa) up to 1.2 or 1.8 g/mL (corresponding to 10 or 15 ppa). In some embodiments, the proppant-laden treatment fluid may have a relatively low proppant loading in earlier-injected fracturing fluid and a relatively higher proppant loading in later-injected fracturing fluid, which may correspond to a relatively narrower fracture width adjacent a tip of the fracture and a relatively wider fracture width adjacent the wellbore. For example, the proppant loading may initially begin at 0.48 g/mL (4 ppa) and be ramped up to 0.6 g/mL (6 ppa) at the end.

### EXAMPLES

### Example 1

Hypochlorite was obtained by electrolysis of 5% sodium chloride solution using graphite electrodes having surface area of 10 cm2 and spaced 0.5 cm apart. Applied voltage was 12V DC. Taken volume of sodium chloride solution was 100 ml. After 15 min of electrolysis a 10 ml sample was separated. pH sample was adjusted to 1 by adding hydrochloric acid. Presence of hypochlorite in the sample was confirmed by reaction with KI in the presence of starch which resulted in changing sample color to blue. No hypochlorite presence was found in the original sodium chloride solution and used hydrochloric acid using the similar analytical reaction.

### Example 2

Sodium hydroxide was formed by electrolysis of 0.1M of sodium acetate solution using graphite electrodes having surface area of 10 cm2 and spaced 0.5 cm apart. Applied voltage was 12V DC. Taken volume of sodium acetate solution was 100 ml. After 10 mmin of electrolysis formation of sodium hydroxide was indicated by pH increase from 9 to 12 units measured by a pH strip.

While the embodiments have been illustrated and described in detail in the drawings and foregoing description, the same is to be considered as illustrative and not restrictive in character, it being understood that only some embodiments have been shown and described and that all changes and modifications that come within the spirit of the embodiments are desired to be protected. It should be understood that while the use of words such as ideally, desirably, preferable, preferably, preferred, more preferred or exemplary utilized in the description above indicate that the feature so described may be more desirable or characteristic, nonetheless may not be necessary and embodiments lacking the same may be contemplated as within the scope of the disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

We claim:

1. A method to supply a treatment fluid downhole to a well, comprising:
flowing a treatment fluid through a treating line in a flow path to a downhole location in the well; and
electrolyzing the treatment fluid in the flow path to form one or more electrolysis products in the treatment fluid.

2. The method of claim 1, wherein the treatment fluid comprises one or more electrolysis reactants, dispersed in an electrically conductive fluid, and converted to the one or more electrolysis products in the electrolyzing.

3. The method of claim 1, wherein the treatment fluid comprises aqueous halide salt converted to hypohalite in the electrolyzing.

4. The method of claim 3, wherein the treatment fluid comprises a viscosified fracturing fluid and the hypohalite is a breaker for the fracturing fluid.

5. The method of claim 1, wherein the treatment fluid comprises one or more carboxylic acids to form carbon dioxide and hydroxyl ion in the electrolyzing to raise the pH of the treatment fluid.

6. The method of claim 5, wherein the treatment fluid comprises a crosslinkable component and the raising of the treatment fluid pH activates crosslinking of the crosslinkable component.

7. The method of claim 1, further comprising controlling a rate of formation of the one or more electrolysis products by adjusting amperage between electrodes disposed in electrically conductive relation with the treatment fluid.

8. The method of claim 7, further comprising modulating the amperage to form a heterogeneous concentration of the one or more electrolysis products in the treatment fluid.

9. The method of claim 1, further comprising passing the treatment fluid through an electrolysis cell integrated into the flow path.

10. The method of claim 9, wherein the electrolysis cell comprises spatially separated electrodes.

11. The method of claim 10, wherein the electrodes are positioned upstream of the well and spatially separated across a pump in the treating line.

12. The method of claim 10, wherein a first one of the electrodes is disposed in the treating line and a second one of the electrodes of opposite polarity to the first one of the electrodes is disposed in a tank in fluid communication with the treating line.

13. The method of claim 10, wherein at least one of the spatially separated electrodes is disposed downhole in the well.

14. A system to supply a treatment fluid downhole to a well, comprising:
an electrically conductive treatment fluid source;
a motive unit to flow the treatment fluid through a treating line in a flow path from the treatment fluid source to a downhole location in the well;
an electrolysis cell comprising a plurality of electrodes disposed in electrically conductive relation with the treatment fluid and comprising at least one of the electrodes integrated in the flow path; and
an electrical source to apply a voltage across the plurality of electrodes to form one or more electrolysis products in the treatment fluid.

15. The system of claim 14, wherein the treatment fluid comprises one or more electrolysis reactants to form the one or more electrolysis products.

16. The system of claim 14, wherein the treatment fluid comprises aqueous halide salt and the one or more electrolysis products comprise hypohalite.

17. The system of claim 16, wherein the treatment fluid comprises a viscosified fracturing fluid and the hypohalite is a breaker for the fracturing fluid.

18. The system of claim 14, wherein the treatment fluid comprises one or more carboxylic acids and the one or more electrolysis products comprise pH modifiers to raise the pH of the treatment fluid.

19. The system of claim 18, wherein the treatment fluid comprises a crosslinkable component and the pH modifiers are activators to activate crosslinking of the crosslinkable component.

20. The system of claim 14, further comprising a controller to adjust amperage and voltage between the electrodes.

21. The system of claim 14, wherein the electrolysis cell is positioned upstream of the well.

22. The system of claim 14, wherein the electrolysis cell is positioned downhole in the well.

23. The system of claim 14, wherein the motive unit comprises a pump and the electrodes are spatially separated across a pump in the treating line.

24. The system of claim 14, wherein a first one of the electrodes is disposed in the treating line and a second one of the electrodes of opposite polarity to the first one of the electrodes is disposed in a tank in fluid communication with the treating line.

25. A method to treat a subterranean formation penetrated by a wellbore, comprising:
providing a treatment fluid stage comprising a particulate-containing substage comprising a self-agglomerating solid composition;
injecting the treatment fluid stage above a fracturing pressure through a treating line and a wellbore in a flow path to a fracture in the formation;
modulating amperage to an electrolysis cell in the flow path to form a heterogeneous concentration of one or more electrolysis products to transform the self-agglomerating solid composition in the fracture into a channelized solids pack comprising clusters having a high concentration of solids, wherein the clusters are separated by open voids having a substantially reduced concentration of solids between the clusters; and
closing the fracture onto the clusters.
